(19) United States
(12) Patent Application Publication
(10) Pub. No.: US 2003/0146931 A1
(43) Pub. Date: Aug. 7, 2003

(54) Method and apparatus for inputting secret information using multiple screen pointers

(76) Inventors: Eon Cheol-Shin, Inchon (KR); Young-Gi Kim, Inchon (KR); Eun-Sang Lee, Inchon (KR); Senng-Pyo Eun, Inchon (KR); Baek-Un Kim, Seoul (KR); Hak-Jae Shin, Suwon (KR); Tae-Ho Kim, Seoul (KR); Chae-Ho Cho, Seoul (KR)

Correspondence Address: KNOBBE MARTENS OLSON & BEAR LLP, 2040 MAIN STREET, FOURTEENTH FLOOR, IRVINE, CA, 92614, US

(21) Appl. No.: 10/067,627

(22) Filed: Feb. 4, 2002

(51) Int. Cl. G09G 5/00

(52) U.S. Cl. 345/741

(57) ABSTRACT

The present invention relates to a method and apparatus for inputting secret information by using multiple screen pointers. Specifically, the present invention relates to the method and apparatus which prevents the third party from detecting or recognizing the contents of the information directed to a certain system through the network and its input process. In accordance with the present invention, the method of inputting secret information by using multiple screen pointers comprises the displaying multiple screen pointers including at least two screen pointers each of which is identified by each of at least two identification symbols, respectively, defining a plurality of character regions each of which is corresponds to each of a plurality of characters, respectively, and receiving selection of at least two of the character regions by a user wherein the selection is performed by using the multiple screen pointers.

### RELATED APPLICATIONS

This application is related to U.S. Patent Application No. (not assigned), filed concurrently herewith and entitled “METHOD AND APPARATUS FOR INPUTTING SECRET INFORMATION”, which is hereby incorporated by reference herein.

This application claims for the benefit of earlier filing dates under 35 U.S.C. §365 (c) of International Application No. PCT/KR00/00662 filed Jun. 24, 2000, designating the United States and claiming for the benefit of the earlier filing date under 35 U.S.C. §365 (b) of Korean Patent Application No. 2000/0030570 filed Jun. 3, 2000; and International Application No. PCT/KR00/01036 filed Sep. 9, 2000, designating the United States and claiming the benefit of the earlier filing dates under 35 U.S.C. §365 (b) of Korean Patent Application Nos. 2000/0030570 filed Jun. 3, 2000 and 2000/47930 filed Aug. 18, 2000. International Application No. PCT/KR00/00662 was published in English as WO 01/98924 A1 on Dec. 27, 2001, and International Application No. PCT/KR00/01036 was published in English as WO 01/99338 A1 on Dec. 27, 2001. This application incorporates by reference International Publications WO 01/98924 A1 and WO 01/99338 A1.

### BACKGROUND OF THE INVENTION

1. Field of the Invention

The present invention relates to a method and apparatus for inputting secret information using multiple screen pointers, and especially to a method and apparatus for preventing the unauthorized from recognizing the input process or the input contents of the secret information while a user accesses to a specific system or inputs secret information.

2. Description of the Related Technology

Conventional methods for inputting secret information may include following examples.

First example of the conventional method is to display the inputted secret information according to the predetermined manner or using the same symbols instead of displaying inputted information themselves to prevent the secret information from draining to a third person.

According to the first example, an input window requesting input of the secret information is displayed whenever a user accesses to an information providing system. Then, the secret information inputted by the user should be displayed as predetermined symbols that the third person cannot recognize. Examples of the predetermined symbols may include a series of “*” or “#” or blanks instead of the secret information themselves inputted by the user.

However, the conventional method has following problems. First, if the third person remembers the keystrokes of the user, the secret information is revealed even though the secret information is not displayed in the form of characters. Further, the inputted secret information may be revealed by repeatedly inputting various possible combinations of key inputs. Or, the third person can reveal the secret information by hacking the user's computer. For example, hacking for memorizing the key input of the user's keyboard may reveal the inputted secret information.

Second example of the conventional method is to save or transfer irregularly transformed secret information. According to the second conventional method, a service provider provides a set of random numbers to the user who inputs the secret information, and the user combines the secret information with the random numbers by using a proper transfer function then transfers the transformed secret information. The above method is called random number combination input method. Another example using random numbers is a random number index input method where the service provider and the user hold the random number index value of the previously agreed random number table in common and the user inputs the random numbers corresponding to the random number index value.

However, the above-mentioned conventional method has following problems. First, the random numbers may be drained when the random numbers are transferred to the user according to the random number combination input method. Further, transforming functions may be revealed by the repeated hacking or through various channels. In the method of random number index input, the secret information is revealed more easily than the random number combination input method when the random number table is lost or stolen. The method of transferring irregularly transformed secret information is more safe than the other methods, however, the function is limited only to the password input and various information such as the identification number, account number, credit card number or secret message to be kept back cannot be inputted.

### SUMMARY OF CERTAIN INVENTION ASPECTS

The present invention was made to solve the above described problems of the conventional methods. The present invention is to prevent secret information from being revealed to a third person. The present invention provides a method and an apparatus for inputting or transferring the secret information such as the identification number, account number, credit card number or secret message as well as the password.

One aspect of the present invention provides a method for inputting secret information using multiple screen pointers. The method comprises displaying multiple screen pointers, at least two of which can be identified by each of at least two identifiers, respectively, on a screen; defining a plurality of character regions each of which corresponds to each of a plurality of characters, respectively, on said screen; and receiving a selection of a user of at least two regions among said plurality of character regions using said multiple screen pointers. The method further comprises selecting one identifier among said identifiers and notifying said selected identifier to said user; and extracting a character corresponding to the region selected by the screen pointer corresponding to said selected identifier among said selected at least two regions after said selecting a character region and receiving a selection. The method may further comprise receiving one identifier selected by said user among said identifiers; and extracting a character corresponding to the region selected by the screen pointer corresponding to said selected identifier among said selected at least two regions after said selecting a character region and receiving a selection.

In the method, said screen pointers have substantially same shape with each other, and said screen pointers are identified by the location on said screen at a specific time point. Said selected identifier is displayed in an encrypted form on said screen in said selecting identifier. Said selecting identifier comprises the selecting one identifier among said identifiers and posting said selected identifier to said user using a separate communication means. Said selected identifier is received in an encrypted form by said user in said receiving identifier. Said receiving identifier comprises the receiving said selected identifier from said user using a separate communication means,, Said extracting character comprising the extracting a character corresponding to the region where a screen pointer corresponding to said identifier is located using a location information of said multiple screen pointers on said screen when said multiple screen pointers selects at least two regions among said plurality of character regions.

Said receiving selection comprises: moving simultaneously each screen pointer composing said multiple screen pointers on said screen linked to said user's operation of moving a displacement input means; and saving the locations of said screen pointers composing said multiple screen pointers on said screen in response to said user's operation of pressing a key input means. Said receiving selection comprises: moving simultaneously each screen pointer composing said multiple screen pointers on said screen linked to said user's operation of pressing a key input means; and saving the locations of said screen pointers composing said multiple screen pointers on said screen in response to said user's operation of pressing a key input means. Said receiving selection comprises: moving simultaneously each screen pointer composing said multiple screen pointers on said screen linked to detecting the motion of external object; and saving the locations of said screen pointers composing said multiple screen pointers on said screen in response to the movement of external object.

Another aspect of the present invention provides An apparatus for inputting secret information using multiple screen pointers. The apparatus comprises means for displaying multiple screen pointers including at least two screen pointers each of which can be identified by each of at least two identifiers, respectively, on a screen; means for defining a plurality of character regions each of which corresponds to each of a plurality of characters, respectively, on said screen; and means for receiving a selection of a user of at least two regions among said plurality of character regions using said multiple screen pointers. The apparatus further comprises means for selecting one identifier among said identifiers and notifying said selected identifier to said user; and means for extracting a character corresponding to the region selected by the screen pointer corresponding to said selected identifier among said selected at least two regions after said selecting a character region and receiving a selection. The apparatus may further comprise means for receiving one identifier selected by said user among said identifiers; and means for extracting a character corresponding to the region selected by the screen pointer corresponding to said selected identifier among said selected at least two regions.

In the apparatus, said screen pointers have substantially same shape with each other, and said screen pointers are identified by the location on said screen at a specific time point. Said means for selecting identifier displays said selected identifier in an encrypted form on said screen. Said means for selecting identifier further comprising a communication means for selecting one identifier among said identifiers and posting said selected identifier to said user. Said means for selecting identifier receives said selected identifier in an encrypted form by said user. Said means for selecting identifier comprises a means for receiving said selected identifier from said user using a separate communication means. Said means for extracting character comprising a means for extracting a character corresponding to the region where a screen pointer corresponding to said identifier is located using a location information of said multiple screen pointers on said screen when said multiple screen pointers selects at least two regions among said plurality of character regions.

Said means for receiving selection comprises: a displacement input means linked with the movement of said multiple screen pointers for each screen pointer composing said multiple screen pointers to move simultaneously on said screen; and a key input means for starting the operation of saving the locations of said screen pointers composing said multiple screen pointers on said screen. Said means for receiving selection comprises: a key input means linked with said user's operation for each screen pointer composing said multiple screen pointers to move simultaneously on said screen; and a key input means for starting the operation of saving the locations of said screen pointers composing said multiple screen pointers on said screen. Said means for receiving selection comprises: means for detecting the motion of external object and linked with the motion of external object for each screen pointer composing said multiple screen pointers to move simultaneously on said screen; and a key input means for starting the operation of saving the locations of said screen pointers composing said multiple screen pointers on said screen.

A further aspect of the invention provides a computer-readable recording medium in which secret information input program using multiple screen pointers is recorded. The program features a method comprising: displaying multiple screen pointers including at least two screen pointers, each of which can be identified by each of at least two identifiers, respectively, on a screen; defining a plurality of character regions each of which corresponds to each of a plurality of characters, respectively, on said screen; and receiving a selection of a user of at least two regions among said plurality of character regions using said multiple screen pointers. The method further comprises selecting one identifier among said identifiers and notifying said selected identifier to said user; and extracting a character corresponding to the region selected by the screen pointer corresponding to said selected identifier among said selected at least two regions after said selecting a character region and receiving a selection.

The method may further comprise receiving one identifier selected by said user among said identifiers; and extracting a character corresponding to the region selected by the screen pointer corresponding to said selected identifier among said selected at least two regions after said selecting a character region and receiving a selection. Said screen pointers have substantially same shape with each other, and said screen pointers are identified by the location on said screen at a specific time point. Said selected identifier is displayed in an encrypted form on said screen in said selecting identifier. Said selecting identifier comprises the selecting one identifier among said identifiers and posting said selected identifier to said user using a separate communication means. Said selected identifier is received in an encrypted form by said user in said receiving identifier. Said receiving identifier comprises the receiving said selected identifier from said user using a separate communication means.

Said extracting character comprising the extracting a character corresponding to the region where a screen pointer corresponding to said identifier is located using a location information of said multiple screen pointers on said screen when said multiple screen pointers selects at least two regions among said plurality of character regions. Said receiving selection comprises: moving simultaneously each screen pointer composing said multiple screen pointers on said screen linked to said user's operation of moving a displacement input means; and saving the locations of said screen pointers composing said multiple screen pointers on said screen in response to said user's operation of pressing a key input means. Said receiving selection comprises: moving simultaneously each screen pointer composing said multiple screen pointers on said screen linked to said user's operation of pressing a key input means; and saving the locations of said screen pointers composing said multiple screen pointers on said screen in response to said user's operation of pressing a key input means. Said receiving selection comprises: moving simultaneously each screen pointer composing said multiple screen pointers on said screen linked to detecting the motion of external object; and saving the locations of said screen pointers composing said multiple screen pointers on said screen in response to said user's operation of pressing a key input means.

### BRIEF DESCRIPTION OF THE DRAWINGS

FIG. 1 is a block diagram showing an embodiment of the secret information input system according to the present invention.

FIG. 2 is a flow chart illustrating an embodiment of the secret information input method using multiple screen pointers according to the present invention.

FIG. 3 is a flow chart illustrating another embodiment of the secret information input method using multiple screen pointers according to the present invention.

FIGS. 4a-4f show the process of inputting information for the secret information input method using multiple screen pointers.

FIG. 5 shows an example input window for inputting secret information using multiple screen pointers according to the present invention.

### DETAILED DESCRIPTION OF CERTAIN INVENTIVE EMBODIMENTS

Illegal leaking of the secret information so called information hacking used in this specification includes the following examples. First type of hacking is that the inputted secret information is recognized by the observation. The first type comprises the type of direct observation of the letters on the screen and the type of observation of the operation of the input device such as keyboard when the secret information is displayed as the unrecognizable characters. Second type is to read the input contents of the user's input device such as keyboard or mouse by infiltrating illegal software to user's computer system. Third type is to read the progress contents and information of the service program by infiltrating the Trojan horse or virus that can watch on the computer system and executing program using reverse engineering. Fourth type is that the third person copies the transmitting information illegally when inputted secret information is transferred via network like Internet. Fifth type is to find out by tracing the transferred information repeatedly.

Multiple screen pointers method of the present invention means the input method that two or more character regions are created on the screen, two or more screen pointers which are distinguishable by two or more identifier are displayed, a screen pointer to be used to input information is assigned utilizing a prescribed identifier, and then the information is inputted by selecting character region using assigned screen pointer. There are two different methods for assigning screen pointer to be used to input information utilizing a identifier. One is to assign a screen pointer which has the same shape as the identifier. The other is to assign a screen pointer which locates on the key of the screen keyboard, whose shape is the same as the identifier. There are also two different methods for saving the inputted information, one is to save all the key values inputted using each screen pointers, and the other is to save the location of the screen pointer on the screen, especially the relative movement coordinates.

The character region of the present invention means the region where the alphabet, numeral, symbol, or diagram is displayed on an appropriate position of the screen to input secret information. The screen keyboard of the present invention means the region where the set of character regions corresponding to each character is displayed on the screen.

The identifier of the present invention means an alphabet, numeral, symbol or diagram which is agreed between the input person and the interpreting person to be used to distinguish the screen pointers. The various alternatives may be used as the identifier as well as the symbols. For example, the colors, sizes or shapes may identify screen pointers.

The identifier index method of the present invention means the method that the input person and the interpreting person settle the identifiers using identifier index table or identifier generator in advance, the identifier used to input secret information is designated among a plurality of identifiers, and then the secret information is inputted and interpreted referring to the designated identifier.

The secret information of the present invention includes identification number, credit card number, account number, and authentication number, etc. Such secret information usually consists of alphabets, numerals, and symbols. Each alphabet, numeral, and symbol consisting secret information is called as secret character.

The main reason of the drain of the secret information is that the information that a user inputted is existent in the input/output device and memory of the computer. The input value of the user is inputted via input device and pass through the memory and output device. Therefore, the secret information may be drained in each phase if a third person hacks the user's computer. To prevent the drain of the information, the computer should be made unable to recognize the real value of the information inputted or transferred.

To resolve the above described problem, the present invention make the secret information that the user inputted unidentified to the input/output device and memory of the computer. That is, according to the present invention, a user inputs secret information using multiple screen pointers and the user only know what is the genuine screen pointer among multiple screen pointers. Therefore, it is impossible to find out the genuine secret information from the transferred information to the computer as well as the user's action for input.

According to the present invention, there are many screen pointers on the user's computer screen. Screen pointers move in response to the movement of the displacement input device. A mouse is a typical example of the displacement input device. An identifier for identifying the genuine screen pointer used for inputting the secret information is shared in encrypted manner between the system and the user. The identifier index method which encrypts based on the index table is an example of the encryption method. According to the identifier index method, the identifier index value is transferred from the service provider to the user instead of the identifier itself related to the screen pointer used for inputting secret information. Therefore, the information of the actual identifier is not drained at all. If the identifier is not drained, the illegal drainer cannot know what is the genuine screen pointer among multiple screen pointers, and therefore, the drainer cannot know the actual input value among selected values by the screen pointer. Moreover, the illegal drainer who does not know the genuine identifier cannot input significant information.

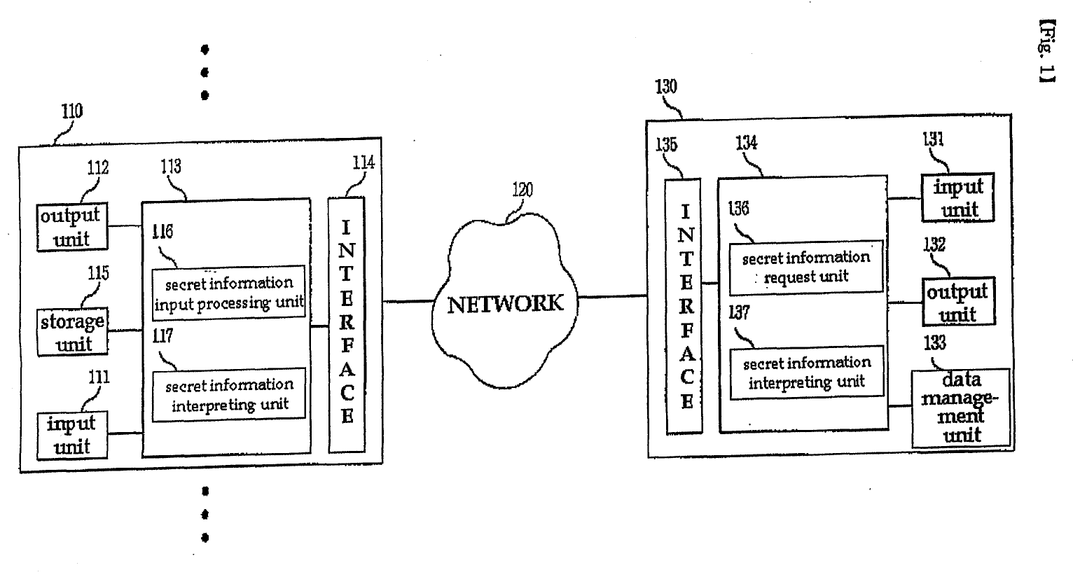

Now, a preferred embodiment of the present invention is described in detail with reference to FIGS. 1-5. FIG. 1 is a block diagram showing an embodiment of the secret information input system according to the present invention.

As shown in FIG. 1, the secret information input system according to the present invention includes a user-side terminal device 110, a server system 130 and a network 120 for connecting the user terminal device 110 and the server system 130. The network 120 may include Internet or Intranet, or wired or wireless network.

The user-side terminal device 110 includes an input unit 111 for inputting information, an output unit 112 for outputting information, an interface 114 for networking, an information processing unit 113 for processing information which is inputted from the input unit 111, transferred from networks through the interface 114 or will be transferred to the output unit 112 and a storage unit 115 for saving various information.

The output unit 112 may preferably be a display device having a display screen. The output unit 112 presents multiple screen pointers, or shows identifier index information received from the server system 130. The input unit 111 receives secret information from the user. The input unit 111 may include a displacement input device linked to the movement of the multiple screen pointers to move simultaneously on the screen, and a key input device for starting the operation of saving the position on the screen of each screen pointer of multiple screen pointers. A representative example of the displacement input device is a mouse, and a representative example of the key input device is a button of the mouse. The output unit 112 and the input unit 111 may be formed in a frame. A touch screen is an example of this embodiment, where the user may watch the screen of the output unit 112 and select character values on the screen by using a finger or a stick.

The input unit 111 receives input from the user using multiple screen pointers method displaying a plurality of screen pointers when a user inputs secret information. Using multiple screen pointers method to input secret information, the problem of information drain of the method using conventional input device is then resolved. The user only can discriminate a genuine screen pointer among multiple screen pointers using identifier index method. The service provider delivers the identifier index value corresponding to the identifier to distinguish the genuine screen pointer to the user, and user can distinguish the genuine screen pointer referring to the delivered identifier index value.

The information processing unit 113 displays multiple screen pointers, sets a plurality of character regions on the screen, and processes user's selection of two or more regions from the plurality of character regions using multiple screen pointers. The information processing unit 113 performs operations in response to a secret information request from the server or interpretation of the secret information inputted by the user. The information processing unit 113 may include a secret information input processing unit 116 for processing secret information inputted by the user and a secret information interpreting unit 117 for interpreting the secret information inputted by the user.

The server system 130 may include an input unit 131, an interface 135 for connecting with a network, an information processing unit 134 for retrieving information out of user information transferred from the network through the interface 135, a data management unit 133 for saving information on users and a identifier index information shared with a corresponding user and an output unit 132 for outputting processed result.

The secret information processing unit 134 of the server system 130 may include a secret information request unit 136 for requesting the user-side terminal device 110 to input secret information and a secret information interpreting unit 137 for interpreting information transferred from the user.

The secret information request unit 136 manages the identifier index value which is provided to the user, provides the identifier index value and receives secret information from the user. The secret information request unit 136 requests the user for the secret information when the user wants to connect to the server system 130, and provides the user-side terminal device 110 with the identifier index value as many as the number of secret characters included in the secret information. It is preferable that the identifier index values are shared between the operator and the user in advance.

The secret information interpreting unit 137 may comprised of an interpreting module for interpreting secret information out of information from the user. Real secret information is retrieved out of information provided from the user by using the identifier index value transferred when the secret information is inputted.

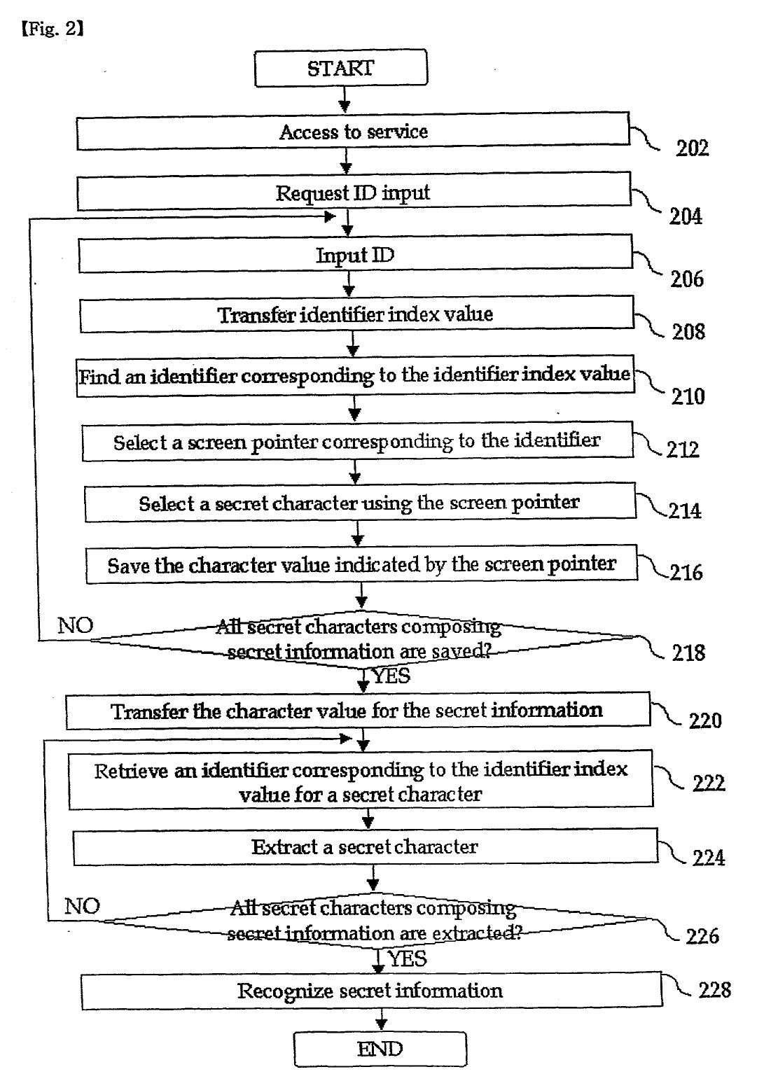

FIG. 2 is a flow chart illustrating an embodiment of the secret information input method using multiple screen pointers according to the present invention. FIG. 5 shows an example input window for inputting secret information using multiple screen pointers according to the present invention.

The information that a user inputs to the server system 130 at the remote is processed as follows.

The user-side terminal device 110 is connected to the server system 130 through the network 120 from a remote place (step 202).

The secret information request unit 136 of the server system 130 requests the user-side terminal device 110 to input user identification (“user ID”) (step 204).

The user inputs his/her own user ID through the input unit 111 of the user-side terminal device 110 (step 206).

The steps of 202, 204 and 206 may be omitted after the process of so-called “user authentication”.

Then, the secret information request unit 136 of the server system 130 requests the user-side terminal device 110 to input secret information. At this step, the identifier index values are also provided to the user (step 208). As for examples of the method for providing the identifier index value, it may be possible to directly display the identifier index value or to use a separate communication unit. The provided identifier index values are saved on the storage unit 115.

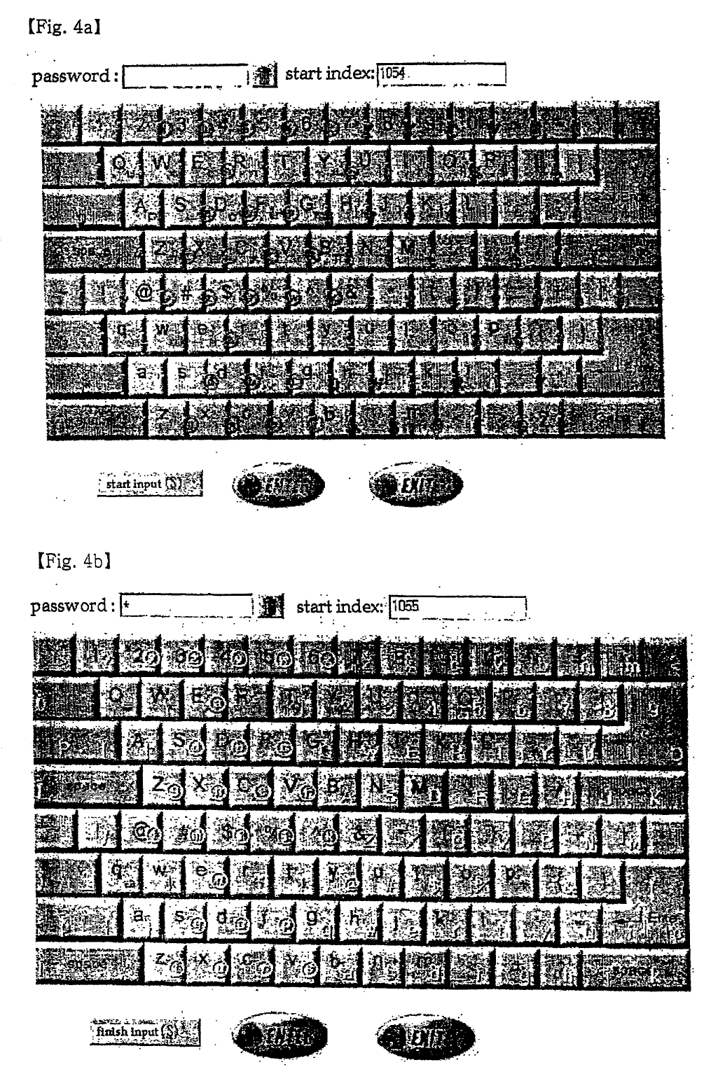

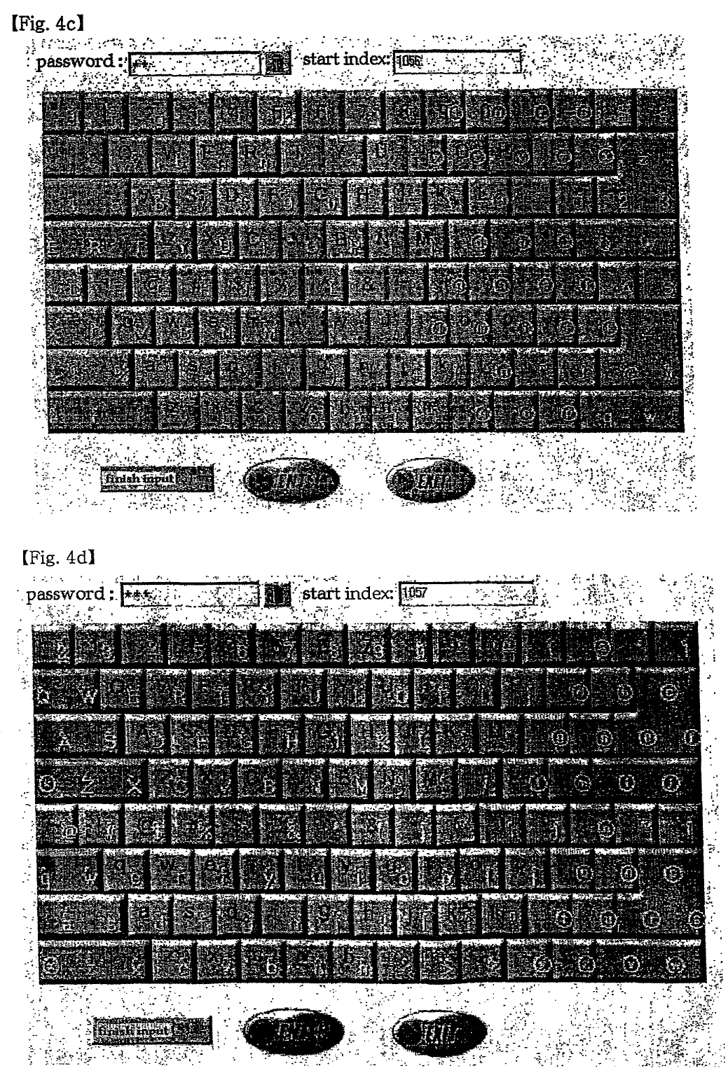

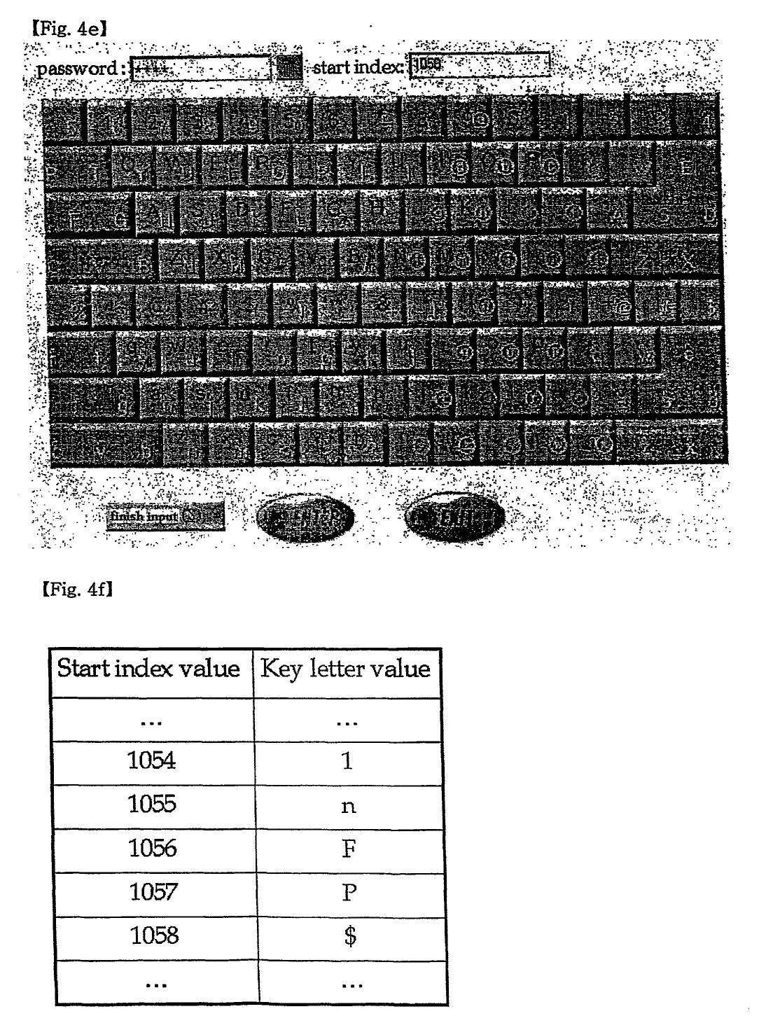

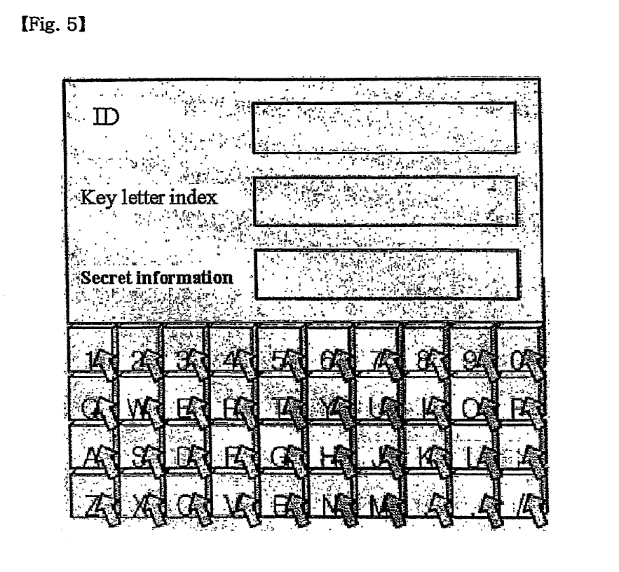

The user-side terminal device 110 displays multiple screen pointers and sets a plurality of character regions, i.e. virtual keyboard. For example, an input window, as shown in FIG. 4a or FIG. 5, may be executed on the output unit 112 of the user-side terminal device 110 in order for the user to input secret information. The input window may include a help-text for explaining inputting of secret information, an information box for showing inputting status of secret information, the identifier index box, and the character regions, i.e. screen keyboard. Screen pointers are displayed on each key position of screen keyboard.

The user recognizes a identifier by referring to the identifier index value shown in the identifier index box (step 210). There are two different ways to select a screen pointer. First one is to select the screen pointer which is identified by the recognized identifier in step 210 as the genuine screen pointer, and the second one is to select a pointer located on the key of the screen keyboard corresponding to the recognized identifier in step 210 at a specific point of time as the genuine screen pointer. According to the first way, in the case of input window as shown in FIG. 4a, if the identifier corresponding to the start index value “1054” is “1” according to FIG. 4f, for example, the screen pointer whose form is “1” would be selected. According to the second way, in the case of input window as shown in FIG. 5, if the identifier corresponding to the start index value “1054” is “1” according to FIG. 4f, for example, the screen pointer on “1” of the screen keyboard.

Character to be inputted is selected on the screen keyboard by moving the selected screen pointer (step 214). At this time, the rest of the screen pointers of multiple screen pointers except the selected screen pointer are moved simultaneously. Therefore, the rest of the screen pointers except the selected screen pointer select another characters although the user selects a specific character to be inputted using selected screen pointer. Then, the computer itself does not recognize what the selected character is as well as a third person looking at the screen.

Exemplary input devices used in the multiple screen pointers method are mouse, keyboard, touch screen, etc. The process of moving multiple screen pointers and selecting a character to input on the screen keyboard using such input devices are described in detail. First, if a mouse is used, screen pointer moves by moving the mouse and whereby moving the whole screen pointers which moves according to the movement of the mouse to the desired position, and the character is selected by clicking the button of the mouse. Second, if a keyboard is used, screen pointer moves by moving the whole screen pointers by key operation of directional keys of the keyboard, and the character is selected by pressing a specific key for character selection. Third, if a touch screen is used, screen pointer moves by moving the screen pointer using a finger or a pen or by pressing a move button on the screen by a finger or a pen, and the character is selected by pressing a specific button on the screen using a finger or a pen while the screen pointer is on the desired position. Fourth, it is possible to combine two or more of the above three ways. That is, process of moving screen pointer and selecting character are performed using different means.

If the characters are inputted, the information processing unit 113 of the user-side terminal device 110 saves information on the whole character values designated by each screen pointers the identifiers, and the process for inputting a secret character composing secret information (step 216).

The above steps for inputting a secret character are repeatedly performed until all of the desired secret characters composing secret information are completely inputted (step 218).

The information processing unit 113 provides to the server system 130 the information on the character values corresponding to the secret characters composing secret information (step 220), where the information on the character values are generated by performing the step 218, as described above (step 220).

The server system 130 retrieves identifiers corresponding to the index values of the identifiers for the secret characters of the secret information provided when the server requests inputting of secret information (step 222).

The secret information interpreting unit 137 extracts one of the secret characters composing secret information by extracting a character value corresponding to the retrieved identifier out of the character values saved in regard to the first secret character of the secret characters provided at the step 220 (step 224).

The above steps 222 and 224 for extracting one secret character are repeatedly performed until all of the inputted secret characters of secret information are extracted (step 226).

The secret information inputted by the user can be recognized by performing the above described steps 222 to 226 (step 228).

According to the present embodiment, screen pointer identifiers are selected, the selected identifiers are notified to the user, and the user inputs secret information using screen pointer corresponding to the notified identifiers. However, it is clear that the present invention is not limited to this embodiment. For example, it is possible to embody the present invention without performing the step of selecting the screen pointer identifiers. In this case, the user may decide identifiers used for inputting secret information at his/her own discretion and input the secret information by using the determined identifiers.

Further, the present invention can also be applicable to the case where the user determines identifiers used for inputting secret information at his/her own discretion, inputs secret information by using the determined identifiers and provides identifier information for identifying selected screen pointer to the secret information interpreting system. In this case, only the user knows identifiers used for inputting secret information, and the secret information interpreting system can interpret the secret information by using the identifiers provided from the user.

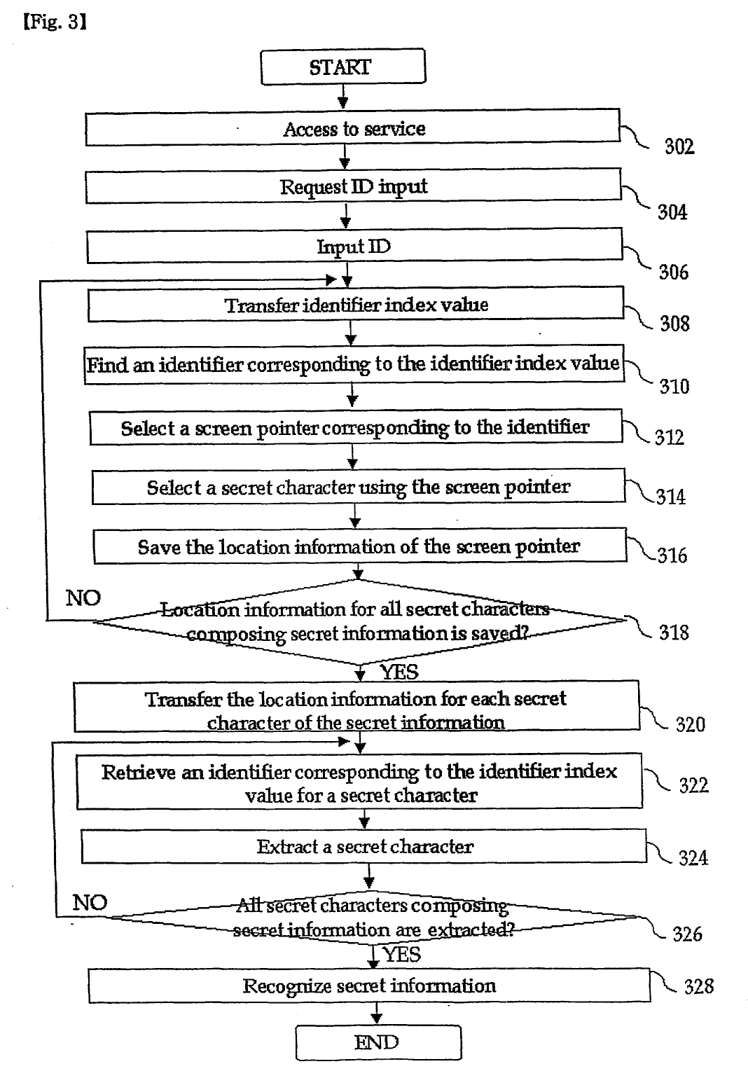

FIG. 3 is a flow chart illustrating another embodiment of the secret information input method using multiple screen pointers according to the present invention.

The information that a user inputs to the server system 130 at the remote is processed as follows.

The input process of a secret character composing secret information after the service user accesses the server system 130 (steps 302 to 314) is the same as the process (steps 202 to 214) described with reference to FIG. 2.

The information processing unit 113 of the user-side terminal device 110 saves the location information of the screen pointer on the screen to the storage unit 115 after a secret character composing secret information of the user is inputted through steps 302 to 314 (step 316). The location information may be the absolute coordinate of the screen pointer on the screen or the relative coordinate transformed therefrom. This process is different from that of FIG. 2.

The above steps 310 to 316 are repeated as many times as the number of the secret characters of secret information inputted by the user (step 318).

The information processing unit 113 provides to the server system 130 with the location information on the secret characters composing secret information stored in the storage unit 115, form example, relative coordinates generated through step 318 (step 320).

The server system 130 grasps identifiers corresponding to the index values of the identifiers for the secret characters of the secret information provided when the server requests inputting of secret information (step 322).

Then, the location information of screen pointer identified by the grasped identifiers through the steps 320 and 322 is retrieved. For example, the location information is retrieved by adding transferred relative coordinate to the start coordinate of the screen pointer. Next, a secret character consisting secret information is retrieved by extracting the character that the user inputted using location information (step 324).

The above steps 322 and 324 are repeated as many times as the number of the secret characters of secret information inputted by the user (step 326). The secret information inputted by the user can be recognized by performing the above described steps 322 to 326 (step 328).

If the method shown in FIG. 2 that the character values indicated by the screen pointers are saved and then transferred (step 216) is used, the process on the server system 130 is fast but the network 120 should carry a big load.

On the other hand, if the method shown in FIG. 3 that the location information of the screen pointer is saved (step 316) is used, user-side terminal device 110 and network 120 does not have a load but the processing amount of the server system 130 is increased.

Therefore, proper method should be selected according to the constitution of the system. Moreover, information input method using multiple screen pointers described with reference to FIGS. 2 and 3 is not confined to the embodiment of on-line system as shown in FIG. 1.

According to another embodiment of the present invention, information input method using multiple screen pointers described with reference to FIGS. 2 and 3 is embodied on a stand-alone system which is not connected to a network. This embodiment is described in detail with reference to FIG. 1. In this stand-alone system, both the user-side terminal device 110 and the server system 130 form a single body system. The network 120 shown in FIG. 1 can be regarded as an internal bus or data line of the single body system.

Now, operation of the above described single body system is described with reference to FIG. 2.

First, the user starts the secret information inputting method on the single body system (step 202). The secret information request unit 136 request the user to input his/her user ID (step 204). The user inputs the user ID through the input unit 111 (step 206). The steps of 202, 204 and 206 may be omitted after the process of so-called “user authentication”.

Then, the secret information request unit 136 requests the user to input secret information. At this step, the identifier index values are also provided to the user (step 208). As for examples of the method for providing the identifier index values, it may be possible to directly display the identifier index values on the screen of the user-side terminal device 110 or to use a separate communication unit.

The output unit 112 displays multiple screen pointers, and sets a plurality of character regions, i.e. virtual keyboard. Details of the input window displayed on the screen are similar to those described above for the first embodiment.

The service user recognizes an identifier by referring to identifier index values shown in the identifier index box (step 210). The service user selects a screen pointer using the identifier recognized in the step 210 (step 212). The service user selects a character to input on the screen keyboard by moving selected screen pointer (step 214). The rest screen pointers of the multiple screen pointers except the selected screen pointer are moved simultaneously with the selected screen pointer as in the previous embodiments.

If the character is inputted, the information processing unit 113 saves all the character values indicated by each screen pointer to the storage unit 115, and the process for inputting a secret character composing secret information is completed (step 216). The above steps 210 to 216 for inputting a secret character are repeated as many times as the number of the secret characters of secret information inputted by the user (step 218).

The system 130 retrieves identifiers corresponding to the identifier index values for the secret characters of the secret information provided when the server requests inputting of secret information (step 222).

The secret information interpreting unit 137 extracts one of the secret characters composing secret information by extracting a character corresponding to the retrieved identifier in step 222 out of the character values stored in regard to the first secret character of the secret characters provided through said step 220 (step 224).

The above steps 222 and 224 are repeated as many times as the number of the secret characters of secret information inputted by the user (step 226).

As described above, according to the stand-alone system, no information is transferred through the network 130. In response to the secret information request of the secret information request unit 136, the user inputs secret information through the input unit 131 following the steps described referring to in FIGS. 2 and 3. Then, the required data is saved in the data management unit 133, and the secret information interpreting unit 137 interprets the information inputted by the user by using data saved in the data management unit 133.

According to another embodiment of the present invention, an input system for user to input secret information and an interpreting system for interpreting the secret information inputted by the user may be formed independently of each other to embody the present invention. This embodiment is analogous to the above-described embodiment where a user-side terminal device is connected to a server system through a network, and detailed explanation is omitted. However, in this embodiment, since the input system is not networked with the interpreting system, the information communication between them is performed by external media, such as a diskette or a CD-ROM.

Examples of stand-alone system may include following applications. First, a user wants to lock his/her own computer system. Second, a user wants to have a password to his/her files. Third, a user wants to save a private message or to transfer the message to a third person.

Besides, as described above, in various situations that the secret information should be inputted off-line, said stand-alone system may be used to input secret information. That is, information input method using multiple screen pointers method as described in FIGS. 2 and 3 can be variously used on off-line terminals.

FIGS. 4a-4f show the process of inputting information for the secret information input method using multiple screen pointers. It is to describe the information input process (steps 210 to 218 and 310 to 318) shown in FIG. 2 or 3 as example information of “TEST”. Then, FIG. 4f illustrates identifier index table used in the process shown in FIGS. 4a-4e.

If a service user accesses to a server system 130 (step 202) and inputs ID (step 204), a start index value is transferred as “1054” as shown in FIG. 4a and it is found that the character corresponding to “1054” is “1” using identifier index table (FIG. 4f). Then, the user finds a screen pointer distinguishable by the identifier “1” among the screen pointers on the screen keyboard, for example, a screen pointer whose form is the same as the identifier “1”. For example, a screen pointer whose form is the same as the identifier “1” is located on the character region “t” of screen keyboard in FIG. 4a. Next, the user moves the screen pointer corresponding to the identifier “1” to the character “T” which is the secret character to input. FIG. 4b shows a screen after the user moves the screen pointer corresponding to the identifier “1” to the character region on “T” to input. After moving the screen pointer as shown in FIG. 4b, the user selects the screen pointer as “T” using key input device, for example, by clicking a button of a mouse.

Then, the next index value is transferred as “1055” as shown in FIG. 4b to input a second secret character, and it is found that the identifier corresponding to “1055” is “n” using identifier index table. The user finds a screen pointer having the form of “n”. In FIG. 4b, the screen pointer having the form of “n” is located on the character region “=”. The user moves the screen pointer corresponding to the identifier “n” to the character region “E” corresponding to the secret character to input. FIG. 4c shows a screen after the user moves the screen pointer corresponding to the identifier “n” to the character region on “T”. After moving the screen pointer as shown in FIG. 4c, the user selects “E”.

After completing the input of “E” using screen pointer, the index value for third secret character is transferred as “1056” as shown in FIG. 4c, and the user finds that the identifier corresponding to “1056” is “F” using identifier index table. Then, the user finds a screen pointer having the form of “F” among the screen pointers on the screen keyboard. In

FIG. 4c, the screen pointer having the form of “F” is located on the character region “!”. The user moves the screen pointer corresponding to the identifier “F” to the character region “S” corresponding to the secret character to input. FIG. 4d shows a screen after the user moves the screen pointer corresponding to the identifier “F” to the character region “S”. Then, the user selects “S” using the screen pointer.

The index value for fourth secret character is transferred as “1057” as shown in FIG. 4d, and the user finds that the identifier corresponding to “1057” is “P” using identifier index table. Then, the user finds a screen pointer having the form of “P” among the screen pointers on the screen keyboard. In FIG. 4d, the screen pointer having the form of “P” is located on the character region “I”. The user moves the found screen pointer to the character region “T” corresponding to the secret character to input. FIG. 4e shows a screen after the user moves the screen pointer corresponding to the identifier “P” to the character region “T”. Then, inputting all four secret characters by selecting “T” using the screen pointer finishes the input of secret information.

The present invention can be applicable to the following examples.

First, it can be used to transferring national secret information. Second, it can be used to input account information of bank account and stock account, password, and credit information. Third, it can be used to input credit card information in electronic transaction. Fourth, it can be used to input password in Internet service and game service. Fifth, it can be used to transfer private secret messages. Sixth, it can be used to save and confirm secret information. It should be noted that the above descriptions are examples of elements, operations or performances which can be embodied by the multimedia content providing service system and method of the present invention and that the present invention is not limited to what are described here. Especially, the present invention can be preferably applied to the on-demand multimedia contents providing services, but can be applied also to any type of multimedia contents providing services only if the multimedia contents and advertisement contents provided are digitized.

The present invention described above has a predominant advantage that the information is hardly drained by inputting using multiple screen pointers method and identifier index method even though the inputted secret information is saved in the user computer or a third person watches the input operation.

According to the conventional random number index input method or one time password input method, which are conventionally used in bank, if password generator or receiver used in is lost or stolen, the user may have damages from the direct drain of the password. On the other hand, although the identifier index table or identifier generator is lost or stolen, the password is not directly opened in the present invention, and it is impossible to perform authentication using only the identifier index table or identifier generator is lost or stolen.

The present invention has an advantage to prevent user computer from hacking, for example, intercepting character values generated from the keyboard during the input operation of password, which is the problem of the conventional input method using keyboard.

Moreover, secret information is saved and transferred after transformed by multiple screen pointers method according to the present invention, and therefore, the secret information is safe although the information is hacked during transmission.

The method of the present invention may be used to input all the information to be kept safe such as credit card numbers, account numbers, identification numbers, and secret messages as well as passwords.

It is possible to prevent being hacked by repeated tracing since the present invention utilizes identifier index method. Further, it is impossible to input a password illegally since the acquisitor's illegal access is not permitted if the authentication is performed according to the present invention although a service user loses identifier index information.

The advantages of the present invention may be summarized as follows. First, the genuine secret information is not recognized although a third person watches the input operation since the genuine secret information is not recognized through the input process. Therefore, means for preventing the input operation of the secret information from being exposed to someone, for example, a cut-off or a closed room, is not required and the user does not need to care about an observer.

Second, it is impossible that the secret information is leaked although the user-side terminal device is exposed to hacking because the user-side terminal device cannot recognize the substance of the secret information. For example, the secret information is not leaked even if the input contents of the input device such as keyboard and mouse are read by infiltrating illegal software to the computer.

Third, the information is not drained by the hacking through the network since it is impossible to retrieve the substance of the secret information from the transferred information from the user-side terminal device through network like Internet. Finally, there is no need to apply a security solution such as PKI thereby the cost for system construction and maintenance is reduced.

Fourth, the secret information can hardly be traced even if the constant information is repeatedly used since the identifier used as a reference coordinate for input is changed irregularly thereby a regular pattern is not generated.

What is claims is:

1. A method for inputting secret information using multiple screen pointers comprising:
displaying multiple screen pointers, at least two of which can be identified by each of at least two identifiers, respectively, on a screen;
defining a plurality of character regions each of which corresponds to each of a plurality of characters, respectively, on said screen; and
receiving a selection of a user of at least two regions among said plurality of character regions using said multiple screen pointers.

2. The method of claim 1, further comprising:
selecting one identifier among said identifiers and notifying said selected identifier to said user; and
extracting a character corresponding to the region selected by the screen pointer corresponding to said selected identifier among said selected at least two regions after said selecting a character region and receiving a selection.

3. The method of claim 1, further comprising:
receiving one identifier selected by said user among said identifiers; and
extracting a character corresponding to the region selected by the screen pointer corresponding to said selected identifier among said selected at least two regions after said selecting a character region and receiving a selection.

4. The method of claim 1, wherein said screen pointers have substantially same shape with each other, and wherein said screen pointers are identified by the location on said screen at a specific time point.

5. The method of claim 2, wherein said selected identifier is displayed in an encrypted form on said screen in said selecting identifier.

6. The method of claim 2, wherein said selecting identifier comprises the selecting one identifier among said identifiers and posting said selected identifier to said user using a separate communication means.

7. The method of claim 3, wherein said selected identifier is received in an encrypted form by said user in said receiving identifier.

8. The method of claim 3, wherein said receiving identifier comprises the receiving said selected identifier from said user using a separate communication means.

9. The method of claim 2, wherein said extracting character comprising the extracting a character corresponding to the region where a screen pointer corresponding to said identifier is located using a location information of said multiple screen pointers on said screen when said multiple screen pointers selects at least two regions among said plurality of character regions.

10. The method of claim 1, wherein said receiving selection comprises:
moving simultaneously each screen pointer composing said multiple screen pointers on said screen linked to said user's operation of moving a displacement input means; and
saving the locations of said screen pointers composing said multiple screen pointers on said screen in response to said user's operation of pressing a key input means.

11. The method of claim 1, wherein said receiving selection comprises:
moving simultaneously each screen pointer composing said multiple screen pointers on said screen linked to said user's operation of pressing a key input means; and
saving the locations of said screen pointers composing said multiple screen pointers on said screen in response to said user's operation of pressing a key input means.

12. The method of claim 1, wherein said receiving selection comprises:
moving simultaneously each screen pointer composing said multiple screen pointers on said screen linked to detecting the motion of external object; and
saving the locations of said screen pointers composing said multiple screen pointers on said screen in response to the movement of external object.

13. An apparatus for inputting secret information using multiple screen pointers comprising:
means for displaying multiple screen pointers including at least two screen pointers each of which can be identified by each of at least two identifiers, respectively, on a screen;
means for defining a plurality of character regions each of which corresponds to each of a plurality of characters, respectively, on said screen; and
means for receiving a selection of a user of at least two regions among said plurality of character regions using said multiple screen pointers.

14. The apparatus of claim 13, further comprising:
means for selecting one identifier among said identifiers and notifying said selected identifier to said user; and
means for extracting a character corresponding to the region selected by the screen pointer corresponding to said selected identifier among said selected at least two regions after said selecting a character region and receiving a selection.

15. The apparatus of claim 13, further comprising:
means for receiving one identifier selected by said user among said identifiers; and
means for extracting a character corresponding to the region selected by the screen pointer corresponding to said selected identifier among said selected at least two regions.

16. The apparatus of claim 13, wherein said screen pointers have substantially same shape with each other, and wherein said screen pointers are identified by the location on said screen at a specific time point.

17. The apparatus of claim 14, wherein said means for selecting identifier displays said selected identifier in an encrypted form on said screen.

18. The apparatus of claim 14, wherein said means for selecting identifier further comprising a communication means for selecting one identifier among said identifiers and posting said selected identifier to said user.

19. The apparatus of claim 15, wherein said means for selecting identifier receives said selected identifier in an encrypted form by said user.

20. A computer-readable recording medium in which secret information input program using multiple screen pointers is recorded, wherein said program comprises:
displaying multiple screen pointers including at least two screen pointers each of which can be identified by each of at least two identifiers, respectively, on a screen;
defining a plurality of character regions each of which corresponds to each of a plurality of characters, respectively, on said screen; and
receiving a selection of a user of at least two regions among said plurality of character regions using said multiple screen pointers.
